(19) United States
(12) Patent Application Publication
(10) Pub. No.: US 2009/0217506 A1
(43) Pub. Date: Sep. 3, 2009

(54) Method for Introducing and Anchoring at Least One Connecting Element Into and in a Workpiece and Device for Carrying Out Said Method

(76) Inventor: Heiko Schmidt, Lappersdorf (DE)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 12/085,470

(22) PCT Filed: Nov. 21, 2006
(86) PCT No.: PCT/DE2006/002045

§ 371 Date: May 11, 2009

(30) Foreign Application Priority Data
Nov. 24, 2005 (DE) 10 2005 056 378.3

(51) Int. Cl. B23P 19/02; B25C 7/00

(52) U.S. Cl. 29/525; 227/15

(57) ABSTRACT

The invention relates to a method for introducing at least one connecting element into a workpiece using a tool composed of at least one part. In said method, before the connecting element is joined and connected to the workpiece, the tool is precisely aligned in relation to the workpiece by means of at least one locating and centering element that engages with a centering region of the workpiece and by the relative displacement of the tool part and the workpiece. The invention also relates to an associated device.

### BACKGROUND OF THE INVENTION

The invention relates to a method for introducing and anchoring at least one connecting element into and in a workpiece and device for carrying out said method.

The insertion and anchoring of connecting elements, for example in the form of press nuts or bolts, in workpieces made of a permanently deformable material (e.g. sheet metal) by joining and pressing is known in the art and is carried out for example in a press, using a standard punching head and a die, so that the respective connecting element is inserted with one anchoring section into a joining opening in the workpiece (for joining), where it is then anchored by pressing, i.e. by permanent deformation of the material of the workpiece. Also known is the insertion of so-called self-piercing nuts in workpieces, where the respective joining opening is created in the nut by punching and the joining is likewise achieved by pressing.

Especially in a mechanical connection the handling, especially the insertion of the workpieces into the respective tool is carried out by mechanical handling devices, for example robots, on which the workpieces are securely clamped also during joining and pressing of the connecting elements. Such handling systems have relatively large positioning tolerances, so that relatively large tolerances also have to be expected in the positioning of the connecting elements in the workpieces.

Such inaccuracies in the positioning of the connecting elements in the workpieces can cause significant problems during connecting of different workpieces by means of the inserted connecting elements, for example during connecting of automobile body parts with other elements of the vehicle.

It is an object of the invention is to provide a method that enables very exact positioning of the connecting elements in workpieces despite the inevitable tolerances of mechanical handling systems, for example robots.

A special advantage of the invention is that positioning inaccuracies of the mechanical handling systems during insertion of workpieces in tools for insertion of connecting elements are eliminated by alignment of the respective workpiece relative to the tool used for insertion of the connecting elements, therefore enabling highly accurate positioning of the connecting elements in the workpieces.

### SUMMARY OF THE INVENTION

In a preferred embodiment of the invention, at least one element of the tool used for inserting the connecting elements is aligned relative to the workpiece while the workpiece is still clamped in the handling device, namely in relation to a reference element that is provided in the workpiece for alignment and consisting of at least one opening in the workpiece. This opening is then for example the joining opening for the respective connecting element or also a centering opening, which is exactly allocated to the respective joining and connecting position for the connecting element.

In a further possible embodiment of the invention, the respective workpiece is aligned during insertion or after insertion in the tool, namely by at least temporarily loosening the holder for the workpiece on the mechanical handling device.

Fundamentally, it is also possible to combine both embodiments or methods.

### BRIEF DESCRIPTION OF THE DRAWINGS

The invention is described in more detail below with reference to the drawings, which are simplified depictions of the insertion with exact positioning of the connecting element in a workpiece made of a permanently deformable flat material, namely of sheet metal.

FIG. 1 is a side view of an embodiment of the invention;

FIG. 2 is a side view of an embodiment of the invention with a die;

FIG. 3 is a side view of an alternate embodiment of the invention with a die;

FIG. 4 is a side view of an alternate embodiment of the invention with a die;

FIG. 5 is a side view of an alternate embodiment of the invention with a die; and

FIG. 6 shows a simplified depiction of the invention for inserting a nut into an opening of the workpiece.

### DETAILED DESCRIPTION OF THE DRAWINGS

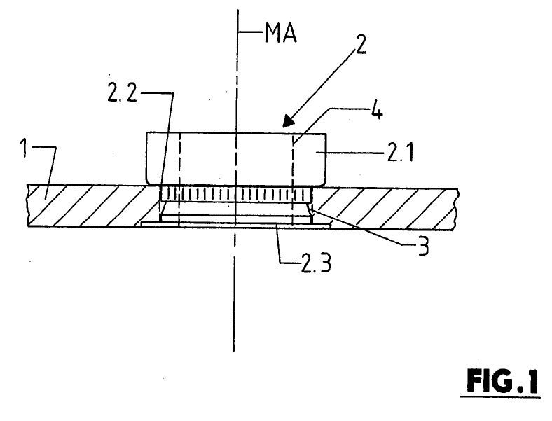

In FIG. 1, 1 generally designates a workpiece made of sheet metal, in which a connecting element in the form of a nut 2 is to be inserted and anchored in an exact position. The nut 2 consists in the known manner for example of a flat, cylindrical nut body 2.1, which is provided on the circumference with a likewise cylindrical projection or flange 2.3, the circumferential surface of which is aligned congruently with the axis MA of the body 2.1 or the nut 2 and is provided with a ring-groove-shaped undercut 3. The nut 2 also comprises an end-to-end nut thread opening 4 aligned congruently with the axis MA.

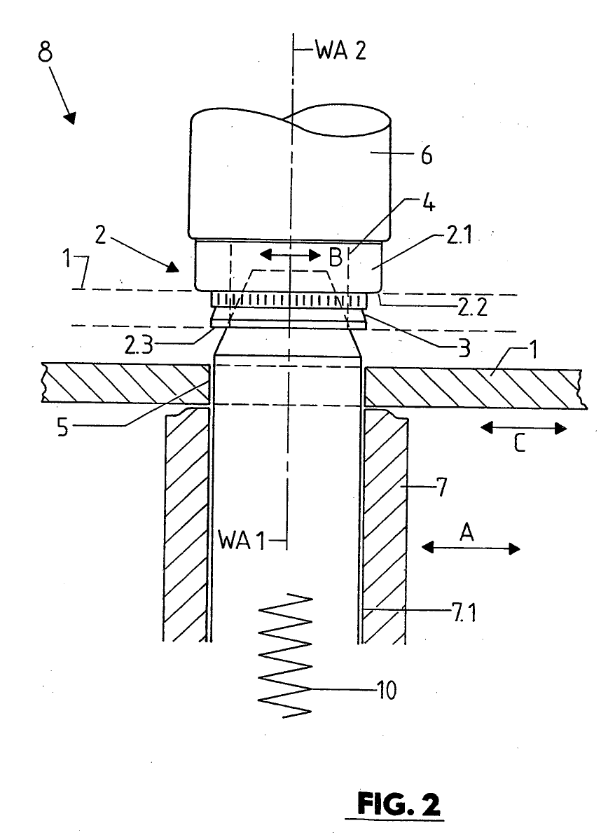

The workpiece 1 is provided with a joining opening 5, the diameter of which is the same as the outer diameter of the flange 2.3 and into which the nut 2 with the flange 2.3 is inserted. The nut 2 is anchored in the workpiece 1 in the known manner by means of pressing, i.e. by permanent deformation of the material of the workpiece 1 into the undercut 3, namely with the aid of a press punch or plunger 6, which exerts force on the top side of the nut 2 facing away from the workpiece 1, and with the aid of a die 7, which forms a ring-shaped support surface enclosing the opening 5 for the bottom side of the workpiece 1 facing away from the nut body 2.1 in the area of the joining opening 5 (FIG. 2). The press punch 6 and the die 7 are parts of the joining and pressing tool 8. The torsionally stable anchoring of the nut 2 in the workpiece 1 is achieved by corresponding contouring of the nut 2 for example in the area of the flange 2.3 or on the ring surface or end face 2.2 radially protruding and bearing against the top of the workpiece 1.

To ensure exact positioning of the nut 2 in the workpiece 1 within minimal tolerance limits, in particular within tolerance limits that are significantly lower than those in handling, for example tolerances that occur during feeding of the workpieces 1 by mechanical devices and/or robots, i.e. to position the nut 2 and the workpiece 1 as accurately as possible for joining and pressing, a pilot and centering pin 9 is provided in the embodiment depicted in FIG. 1 and can be moved coaxially in the ring-shaped die 7 or in a die opening 7.1 located there against the effect of at least one compression spring. The diameter of the die opening 7.1 is equal to or approximately equal to the diameter of the opening.

When the spring 10 is not under tension, the pilot and centering pin 9 protrudes with its top end in FIG. 2 over the plane of the top of the die, against which (plane) the workpiece 1 bears with its bottom side during joining and pressing of the nut 2.

On this end protruding over the die plane when the spring 10 is not under tension the pilot and centering pin 9 first forms a cylindrical section 9.1 starting from said plane, the diameter of which (section) is the same as the diameter of the joining opening 5, and is adjoined by a section 9.2 that is tapered toward the free end.

To insert the nut 2, the workpiece 1 is first inserted into the workpiece 8 with a mechanical device, i.e. holders or gripper arms of a robot or some other mechanical handling device and placed on the die 7, during which the pilot and centering pin 9 is inserted into the joining opening 5. If the axis of the opening is not already by chance aligned congruently with the axis of the pilot and centering pin 9, which is not to be expected due to the tolerances during feeding of the workpiece 1, then the die 7 is moved radially relative to its die or tool axis WA1 by the pilot and centering pin 9 moving into the opening 5, until the section 9.1 is completely held in the joining opening 5 and the tool axis WA1 is aligned with the axis of the opening 5. As a special characteristic, the die 7 in this embodiment is provided radially relative to the die or tool axis WA1 in the tool 8, as indicated by the double arrow A in FIG. 1.

The nut 2 is fed with the lowering plunger 6. The nut 2 is held for example on the end face of the plunger 6 in a suitable manner, e.g. by means of permanent magnets 11 or by some other means, for example by means of a vacuum, etc. When lowered, the tapered section 9.2 enters the nut thread opening 4, so that the nut 2 becomes aligned by radial movement of the nut axis MA before joining, i.e. before insertion of the flange 2.3 into the joining opening 5, as indicated by double arrow B. During continued lowering, axial retraction of the pilot and centering pin 9 causes the flange 2.3 of the nut 2, which is aligned congruently with the tool axis WA1 and with the axis of the opening 5 to enter the opening 5, so that after joining and pressing, the nut 2 is positioned exactly in the workpiece 1.

The special characteristic of this embodiment is therefore that the lower element of the tool 8, namely the die 7, is first aligned by the pilot and centering pin 9 in relation to the axis of the opening 5 and then the nut 2 is threaded with its nut thread opening 4 onto the pilot and centering pin 9 and is therefore aligned exactly relative to the axis of the pilot and centering pin 9 and the opening 5 before joining and pressing. There is no change in the radial position of the axis WA2 of the plunger 6 and of the position of the upper element of the overall tool comprising said plunger to the tool axis WA2.

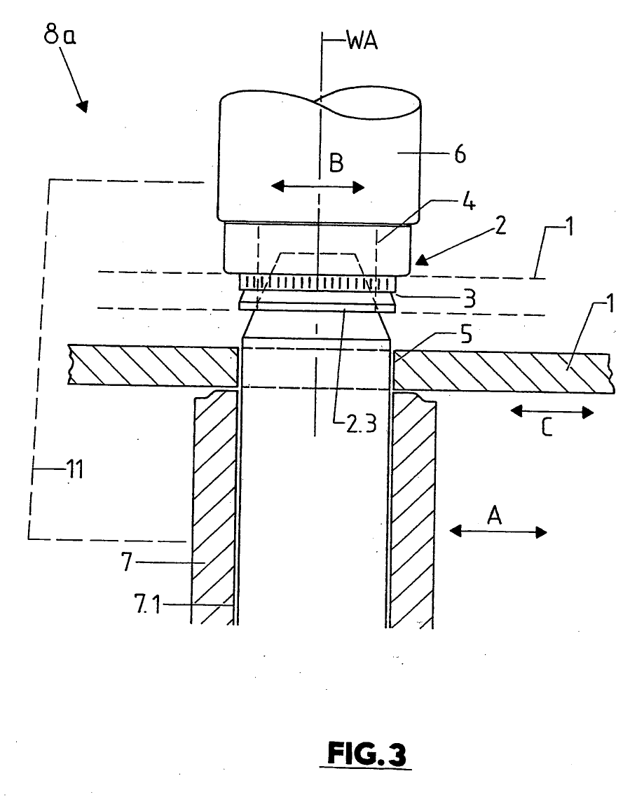

FIG. 3 shows an embodiment that differs from the embodiment of FIG. 2 only in that the entire tool 8a corresponding to the tool 8 for alignment relative to the opening 5 of the workpiece 1 can be moved radially relative to the common tool axis WA of the upper tool element represented by the plunger 6 and of the lower tool element represented by the die 7. For this purpose, the two tool elements are connected with each other by means of a frame structure or other suitable means, at least during closing of the tool, as indicated by line 11.

The procedure for joining and pressing the nut 2 in the workpiece 1 corresponds to the foregoing procedure described for the tool 8, i.e. during insertion of the workpiece 1 into the tool 8a the lower tool element, namely the die 7, is aligned by radial movement with its axis relative to the axis of the opening 5 by positioning the joining opening 5 onto the pilot and centering pin 9. At the same time, during closing of the tool 8a, i.e. during lowering of the upper tool element comprising the plunger 6, this upper element is also aligned by means of the connection with the lower tool element due to radial movement to the tool axis WA relative to the axis of the opening 5.

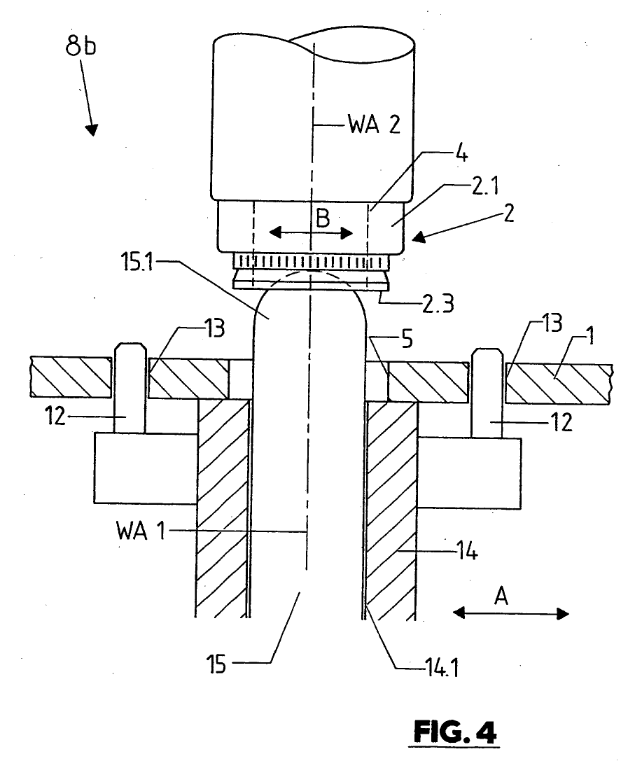

FIG. 4 shows as a further possible embodiment a tool 8b, which differs from the tool 8 or 8a essentially in that instead of the pilot and centering pin 9, which effects the alignment of the lower tool element or die 7 and of the nut 2 relative to the opening 5 in the workpiece 1, two pilot and centering pins 12 are provided, which engage with centering openings 13 provided in the workpiece 1 outside of the opening 5 and allocated to the latter. It goes without saying that the centering openings 13 are exactly aligned relative to each other, in particular also relative to the axis of the corresponding opening 5.

Instead of the die 7, a die 14 is used, which likewise forms a bearing surface for the bottom side of the workpiece 1 facing away from the nut body 2.1 during pressing of the nut 2 into the opening 5 of the workpiece 1. In the die 14, a further pilot and centering pin 15 is axially moveable against the force of at least one compression spring and forms a truncated tapered section 15.1 at least on its end protruding over the die 14 when the spring is not under tension, the maximum diameter of section 15.1 being equal to or slightly greater than the diameter of the nut thread opening 4 of the nut 2. The die 14 is likewise provided with a die opening 14.1, the diameter of which in this embodiment is smaller than the diameter of the opening 5 and corresponds to the diameter of the pilot and centering pin 15, so that the die 14 not only supports the workpiece 1 on the edge area surrounding the opening 5, but the die surface also extends into the opening 5.

During insertion of the workpiece 1, which is securely clamped in a mechanical handling device, e.g. a robot, into the opened tool 8b, the workpiece 1 is placed with its centering openings 13 onto the pilot and centering pins 12, which likewise are provided on the lower tool element or die 14. During this procedure, this lower tool element 14 is likewise aligned by radial movement relative to its tool axis WA1 with the centering openings 13 and therefore with the axis of the opening 5. Afterwards, the nut 2 with its nut thread opening 4 is pushed by the upper tool element, i.e. for example by lowering the plunger 6, onto the tapered area 15.1 of the pilot and centering pin 15 protruding over the top of the workpiece 1, namely with the workpiece 1 bearing against the die 14, so that the nut 2 is centered relative to the tool axis WA1 of the die 14 and therefore relative to the axis of the opening 15 and therefore positioned exactly in the workpiece 1 during pressing. The nut 2 is likewise held “floating” on the upper tool element, so that the latter does not have to be moved radially relative to its tool axis WA2 for centering and exact positioning.

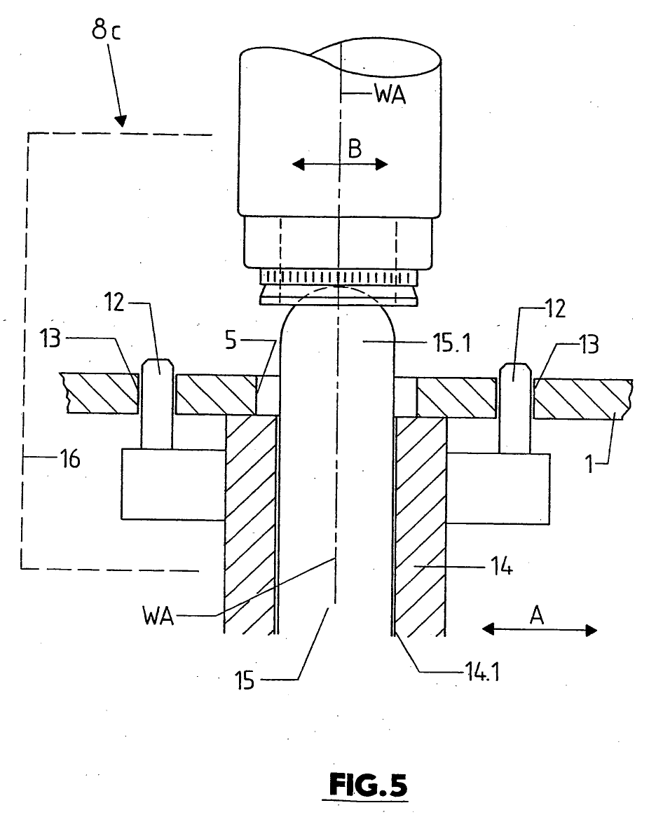

FIG. 5 shows a tool 8c, which differs from the tool 8b in that also the upper tool element represented by the plunger 6 is centered relative to the common tool axis WA, namely likewise by means of the pilot and centering pins 12 engaging in the centering openings 13 and by both tool elements being radially movable relative to the tool axis WA. The upper and lower tool elements are likewise connected with each other at least during closing of the tool for this radial movement, as indicated by the line 16.

The pilot and centering pin 15 is not necessary with the tool 8c.

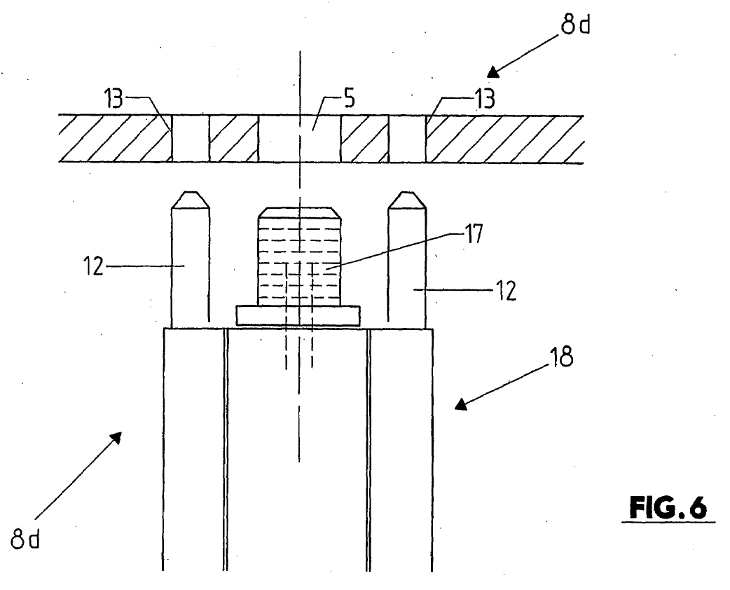

FIG. 6 shows a very simplified depiction of a device 8d for inserting a rivet nut or blind rivet nut 17 into the opening 5 of the workpiece 1. A tool element 18 comprising the standard design for handling rivet nuts is provided for joining and anchoring of the rivet nut 17. The pilot and centering pins 12 that engage with the centering opening 13 are provided on this tool element. When the workpiece 1 is placed in the tool 8d and the workpiece 1 with the centering openings 13 is pushed onto the pilot and centering pins 12, the tool element 18 with the rivet nut 17 is likewise moved radially relative to the axis of the rivet nut 17 so that the axis of the rivet nut 17 is then aligned congruently with the axis of the opening 5. This is followed by the joining and riveting process.

A common characteristic of all of the embodiments described above is therefore that at least one tool element can be moved relative to its tool axis and is centered relative to the axis of the opening 5 during clamping of the workpiece 1, so that the respective connecting element can be joined, i.e. inserted into the opening 5 of the workpiece 1 when the workpiece is in clamped condition without causing mechanical tension to the workpiece.

The embodiments described above also make it possible to insert a plurality of connecting elements, for example a plurality of nuts 2 or rivet nuts 17 into a workpiece 1 in one step, simultaneously and exactly positioned, in which case the tool used for each connecting element consists of at least one tool element that can be centered by radial movement relative to its tool axis by means of the pilot and centering pin 9 or the pilot and centering pins 12.

In deviation from the embodiments described above, it is also possible, prior to joining of the respective connecting element, to align the workpiece 1 relative to the tool elements or the tool with a rigid, i.e. radially not moveable arrangement of the tool elements, namely by loosening the clamping of the workpiece 1 in the handling unit during insertion of the workpiece 1 in the opened tool 8-8d, i.e. during pushing of the workpiece 1 with the opening 5 onto the pilot and centering pin 9 and/or with the centering openings 13 onto the pilot and centering pins 12, so that the workpiece 1 can be aligned by moving relative to the tool elements corresponding to the double arrow C.

The invention was described above for joining and pressing of press nut or rivet nuts. It goes without saying that the methods described above can also be used for inserting other connecting elements in workpieces, for example for inserting bolts or self-piercing nuts in workpieces.

### REFERENCE LIST

1 workpiece
2 press nut
0.1 nut body
0.2 end face of nut body 2.1
0.3 flange
1 undercut
2 nut thread opening
3 opening in workpiece
4 press bolt
5 die
7.1 die opening
8, 8a, 8b, 8c, 8d tool
9 pilot and centering pin
9.1, 9.2 section of the pilot and centering pin 9
10 compression spring
11 mechanical connection between the tool parts
12 pilot and centering pin
13 centering opening
14 die
14.1 die opening
15 pilot and centering pin
15.1 section
16 mechanical connection between the tool parts
17 rivet nut
18 tool for joining and anchoring the rivet nut
A radial movement of the lower tool element
B radial movement of the supplied connecting element or of the upper tool element
C movement of the workpiece for alignment
MA axis of nut
WA1, WA2, WA tool axis

What is claimed is:

1. A method for inserting at least one connecting element into a workpiece using a tool comprising at least one tool element, whereby prior to joining and connecting the connecting element with the workpiece, the tool is aligned exactly in relation to the workpiece by at least one pilot, centering element, or pilot and centering element, acting on a centering area of the workpiece by a relative movement between the tool element and the workpiece.

2. The method according to claim 1, wherein the at least one tool element is aligned by radial movement relative to a tool axis (WA, WA1) in relation to the clamped workpiece.

3. The method for inserting at least one connecting element into a workpiece using a tool comprising at least one tool element, in which prior to joining and connecting of the connecting element with the workpiece, the connecting element is aligned exactly in relation to the workpiece by at least one pilot, centering element, or pilot and centering device, acting on a centering area of the workpiece by relative movement between the connecting element and the workpiece, wherein the tool element is moved radially relative to a tool axis (WA, WA1) in relation to the clamped workpiece during alignment of the connecting element.

4. The method of claim 1, wherein the alignment is achieved by the at least one pilot, centering pin, or pilot and centering pin, engaging in at least one opening of the workpiece.

5. The method of claim 4, wherein a centering opening of the workpiece engaging with the at least one pilot and/or centering pin is a joining opening for the connecting element.

6. The method of claim 1, wherein the at least one centering area in the workpiece is provided to a side of the area of the workpiece provided for anchoring of the connecting element.

7. The method according to claim 6, wherein the at least one centering area is provided to the side of a joining opening (5) for the connecting element.

8. The method according to claim 2, wherein the tool element that is radially movable relative to the tool axis (WA) is a die.

9. The method of claim 1, wherein the respective connecting element, during joining, is guided on a guide element aligned by the at least one pilot, centering element, or pilot and centering element, relative to the workpiece and is held on the tool element aligned by the at least one pilot, and/or centering element or pilot and centering element.

10. The method according to claim 9, wherein the guide element of the pilot or centering pin that aligns the tool element relative to the workpiece is an additional pilot or centering pin.

11. The method according to claim 9, wherein the connecting element is held floating on the additional tool element.

12. The method of claim 1, wherein the connecting element is a nut, selected from a press nut or a self-piercing nut.

13. The method of claim 1, wherein the connecting element is a bolt.

14. The method of claim 1, wherein the connecting element is a rivet, a blind rivet, or a rivet nut.

15. A device for inserting at least one connecting element into a workpiece with at least one tool comprising at least one tool element, having at least one pilot, centering element, or pilot and centering element, acting on a centering area of the workpiece, with which exact alignment of the tool in relation to the workpiece is achieved by a relative movement between the tool element and the workpiece.

16. A device according to claim 15, wherein the at least one tool element can be moved radially relative to its tool axis (WA, WA1) for alignment.

17. A device for inserting at least one connecting element into a workpiece using a tool comprising at least one tool element, with at least one pilot, centering element, or pilot and centering element acting on a centering area of the workpiece, with which the connecting element is aligned exactly in relation to the workpiece by relative movement between the connecting element and the workpiece prior to joining and connecting of the connecting element with the workpiece, whereby the tool element can be moved radially relative to its tool axis (WA, WA1) in relation to the clamped workpiece during alignment of the connecting element.

18. The device according to claim 15, wherein the at least one pilot or centering element is a pilot or centering pin engaging in one opening of the workpiece.

19. The device according to claim 18, wherein the centering opening of the workpiece engaging with the at least one pilot or centering pin is a joining opening for the connecting element.

20. The device according to claim 15, wherein the at least one centering area in the workpiece is provided to a side of the area of the workpiece provided for anchoring of the connecting element.

21. The device according to claim 20, wherein the at least one centering area is provided to a side of a joining opening for the connecting element.

22. The device according to claim 15, wherein the tool element that is radially movable relative to the tool axis (WA) is a die.

23. Device according to claim 15, further comprising a guide element, which is aligned by the at least one pilot, centering element, or pilot and centering element relative to the workpiece and on which the respective connecting element is held during joining.

24. The device according to claim 23, wherein the guide element that aligns the tool element relative to the workpiece is a pilot or centering pin or an additional pilot or centering pin.

25. The device according to claim 15, wherein the connecting element is held floating on an additional tool element.
